(19) United States
(12) Patent Application Publication
(10) Pub. No.: US 2025/0387956 A1
(43) Pub. Date: Dec. 25, 2025

(54) METHOD OF MANUFACTURING MOLDING DIE AND BASE PLATE

(71) Applicant: SEIKO EPSON CORPORATION, Tokyo (JP)

(72) Inventor: Tatsuya TSUBOI, OKAYA-SHI (JP)

(21) Appl. No.: 19/245,518

(22) Filed: Jun. 23, 2025

(30) Foreign Application Priority Data
Jun. 25, 2024 (JP) 2024-101824

(51) Int. Cl. B29C 45/04; B29C 45/00

(52) U.S. Cl. CPC B29C 45/04; B29C 45/0062

(57) ABSTRACT

Assembling a base plate by inserting a second member into an opening portion of a first member, the second member being configured by a plurality of nest members, shaping a stacking that is to be a part of the molding die by ejecting a shaping material onto the base plate and stacking a layer, removing the nest members from the base plate on which the stacking body was shaped, and subjecting the stacking body to a cutting process are involved. During assembling of the base plate, the plurality of nest members are arrayed and inserted to fill the opening portion.

The present application is based on, and claims priority from JP Application Serial Number 2024-101824, filed Jun. 25, 2024, the disclosure of which is hereby incorporated by reference herein in its entirety.

### BACKGROUND

### 1. Technical Field

The present disclosure relates to a method of manufacturing a molding die and a base plate.

### 2. Related Art

JP-A-2023-159914 discloses a method of manufacturing a molding die that improves adhesion strength between a base plate and a stacking body by forming a plurality of through holes in the base plate and ejecting a shaping material onto the base plate so that a part of the shaping material enters the through holes.

However, in the method described in JP-A-2023-159914, although adhesion between the base plate and the stacking body is improved, it is difficult to detach the base plate and the stacking body from each other in a subsequent manufacturing step. As a result, there is a problem of degradation of processing efficiency and prolonged processing time.

### SUMMARY

A method of manufacturing a molding die is a method of manufacturing a molding die used in an injection molding apparatus, and includes assembling a base plate by inserting a second member into an opening portion of a first member, the second member being configured by a plurality of nest members, shaping a stacking that is to be a part of the molding die by ejecting a shaping material onto the base plate and stacking a layer, removing the second member from the base plate on which the stacking body was shaped, and subjecting the stacking body to a cutting process, wherein, during assembling of the base plate, the plurality of nest members are arrayed and inserted to fill the opening portion.

A base plate is a base plate on which a shaping material is stacked, the base plate being used in an injection molding apparatus and including a first member and a second member, wherein the first member is provided with an opening portion, and the second member is configured by a plurality of nest members that are arrayed and arranged to fill the opening portion.

### BRIEF DESCRIPTION OF THE DRAWINGS

FIG. 1 is a schematic view illustrating a configuration of an injection molding apparatus.

FIG. 2 is a perspective view illustrating a configuration of a flat screw.

FIG. 3 is a plan view illustrating a configuration of a barrel.

FIG. 4 is a perspective view illustrating a configuration of a three-dimensional shaping apparatus.

FIG. 5 is a cross-sectional view illustrating a configuration of a shaping unit.

FIG. 6 is a perspective view illustrating a configuration of a molding die including a base plate.

FIG. 7 is a cross-sectional view taken along the line A-A, illustrating the molding die illustrated in FIG. 6.

FIG. 8 is a perspective view illustrating a configuration of the base plate.

FIG. 9 is a perspective view illustrating a configuration of a first member configuring the base plate.

FIG. 10 is a perspective view illustrating a configuration of a nest member configuring a second member.

FIG. 11 is a perspective view illustrating a configuration of the nest member.

FIG. 12 is a flow chart illustrating a method of manufacturing a molding die.

FIG. 13 is a perspective view illustrating a part of the method of manufacturing a molding die.

FIG. 14 is a cross-sectional view illustrating a part of the method of manufacturing a molding die.

FIG. 15 is a perspective view illustrating a part of the method of manufacturing a molding die.

FIG. 16 is a cross-sectional view illustrating a part of the method of manufacturing a molding die.

FIG. 17 is a cross-sectional view illustrating a part of the method of manufacturing a molding die.

FIG. 18 is a perspective view illustrating a part of the method of manufacturing a molding die.

FIG. 19 is a perspective view illustrating a part of the method of manufacturing a molding die.

### DESCRIPTION OF EMBODIMENTS

With reference to the drawings, a method of manufacturing a molding die 600 and a configuration of a base plate 500A are described below. Description is with reference to the drawings in which three axes perpendicular to each other are set as an X-axis, a Y-axis, and a Z-axis. The direction along the X-axis is set as the “X direction.” The direction along the Y-axis is set as the “Y direction.” The direction along the Z-axis is set as the “Z direction.” The direction indicated by the arrow is set as the +direction, and the direction opposite to the +direction is set as the −direction. Note that a view in the +Z direction or the −Z direction is also referred to as plan view or planar view.

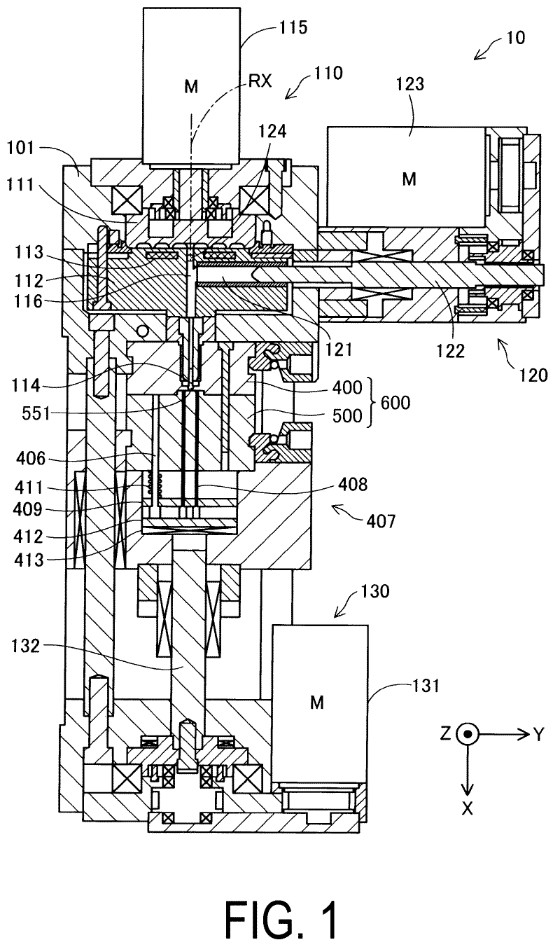

First, with reference to FIG. 1, a configuration of an injection molding apparatus 10 using the molding die 600 is described.

As illustrated in FIG. 1, the injection molding apparatus 10 includes a plasticization device 110, an injection control mechanism 120, a mold clamping device 130, and the molding die 600.

The plasticization device 110 includes a first flat screw 111, a barrel 112, a first heater 113, and a first nozzle 114.

The first flat screw 111 is accommodated in an accommodation unit 101. The first flat screw 111 is also referred to as a scroll or a rotor. The first flat screw 111 is rotationally driven about a rotation axis RX in the accommodation unit 101 by a screw driving unit 115 configured by a driving motor or a speed reduced.

In the embodiment, the X direction is a direction along the rotation axis RX. At the center of the barrel 112, a flow-out hole 116 is formed. An injection cylinder 121, which is described later, is coupled to the flow-out hole 116. In the flow-out hole 116, a check valve 124 is provided upstream of the injection cylinder 121.

The injection control mechanism 120 includes the injection cylinder 121, a plunger 122, and a plunger driving unit 123. The injection control mechanism 120 includes a function of injecting a plasticized material in the injection cylinder 121 into a cavity 551, which is described later. The injection control mechanism 120 controls an injection amount of the plasticized material from the first nozzle 114.

The injection cylinder 121 is a substantially cylindrical member connected to the flow-out hole 116 of the barrel 112, and includes the plunger 122 inside. The plunger 122 slides inside the injection cylinder 121 to pump and feed the plasticized material in the injection cylinder 121 into the first nozzle 114 provided to the plasticization device 110. The plunger 122 is driven by the plunger driving unit 123 configured by a motor.

The molding die 600 includes a movable die 500 and a fixed die 400. The movable die 500 and the fixed die 400 are provided to face each other, and the cavity 551 corresponding to a shape of a molded item is provided therebetween. In the movable die 500 and the fixed die 400, recess and protruding shapes defining the cavity 551 are formed. The recess shape defining the cavity 551 is also referred to as a cavity portion, and the protruding shape is also referred to as a core portion.

The plasticized material flowing out from the flow-out hole 116 of the barrel 112 is pumped and fed by the injection control mechanism 120, and is injected from the first nozzle 114 into the cavity 551. Details of the movable die 500 and the fixed die 400 are described later. The movable die 500 and the fixed die 400 in the embodiment form a resin die including a stacking body 550 in which the cavity 551 is formed, the base plate 500A, and a mold base 560.

The mold clamping device 130 includes a molding die driving unit 131, and includes a function of opening and closing the movable die 500 and the fixed die 400. The mold clamping device 130 drives the molding die driving unit 131 configured by a motor to rotate a ball screw 132, moves the movable die 500 coupled to the ball screw 132 with respect to the fixed die 400, and thus opens and closes the molding die 600. In other words, the fixed die 400 is stationary in the injection molding apparatus 10, and the movable die 500 moves relatively with respect to the fixed die 400 being stationary. With this, the molding die 600 is opened and closed.

The movable die 500 is provided with an extruding mechanism 407 for releasing a molded item from the molding die 600. The extruding mechanism 407 includes an ejector pin 408, a support plate 409, a support rod 406, a spring 411, an extruding plate 412, and a thrust bearing 413.

The ejector pin 408 is a rod-like member for extruding a molded item that is molded in the cavity 551. The ejector pin 408 is provided to pass through the movable die 500 and be inserted into the cavity 551. The support plate 409 is a plate member that supports the ejector pin 408. The ejector pin 408 is fixed to the support plate 409. The support rod 406 is fixed to the support plate 409, and is inserted into a through hole 552 formed in the movable die 500.

The spring 411 is arranged in the space between the movable die 500 and the support plate 409, and is inserted into the support rod 406. At the time of molding, the spring 411 biases the support plate 409 so that the head portion of the ejector pin 408 forms a part of the wall surface of the cavity 551. The extruding plate 412 is fixed to the support plate 409. The thrust bearing 413 is fixed to the extruding plate 412, and is provided so that the head portion of the ball screw 132 is prevented from damaging the extruding plate 412. Note that a thrust slide bearing or the like may be used in place of the thrust bearing 413.

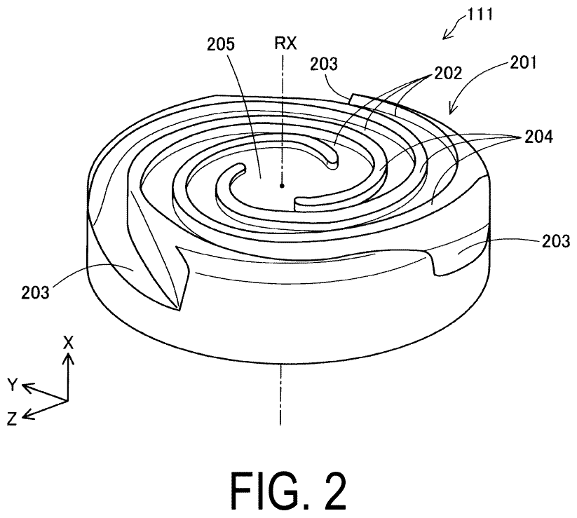

Next, with reference to FIG. 2, a configuration of the first flat screw 111 is described.

As illustrated in FIG. 2, the first flat screw 111 has a substantially cylindrical shape having a height in a direction along the rotation axis RX, which is smaller than the diameter. In a groove formation surface 201 of the first flat screw 111, which faces the barrel 112, a spiral groove 202 is formed around a center portion 205.

The groove 202 communicates with a material inlet 203 formed in a side surface of the first flat screw 111. The material supplied from a material supply unit such as a hopper is supplied to the groove 202 via the material inlet 203. The groove 202 is formed by being separated by a protruding portion 204.

The embodiment illustrates an example in which three grooves 202 are formed. However, the number of grooves 202 may be one, two, or more. Note that the groove 202 is not limited to a spiral shape, and may be a helical shape, an involute curved shape, or a shape extending in an arc from the center portion 205 toward the outer periphery.

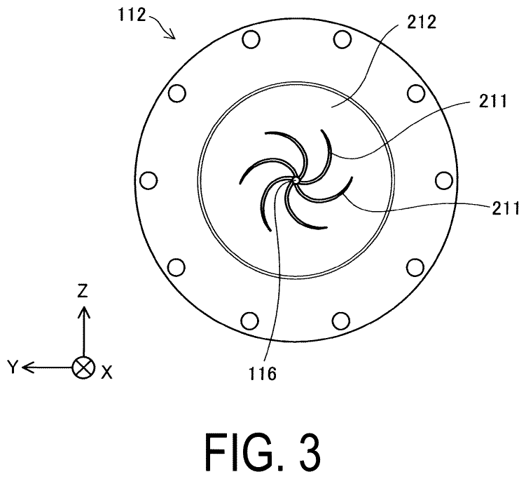

Next, with reference to FIG. 3, a configuration of the barrel 112 is described.

As illustrated in FIG. 3, the barrel 112 includes a facing surface 212 that faces a groove formation surface 201 of the first flat screw 111. At the center of the facing surface 212, the flow-out hole 116 is formed. A plurality of guide grooves 211 are formed in the facing surface 212. The plurality of guide grooves 211 are connected to the flow-out hole 116, and extend from the flow-out hole 116 to the outer circumference.

The material supplied to the groove 202 of the first flat screw 111 is plasticized between the first flat screw 111 and the barrel 112 by rotation of the first flat screw 111 and heating of the first heater 113, simultaneously flows along the groove 202 and the guide groove 211 by rotation of the first flat screw 111, and is guided to the center portion 205 of the first flat screw 111. The material flowing into the center portion 205 is guided the flow-out hole 116 provided at the center of the barrel 112 to the injection control mechanism 120. Note that the barrel 112 may not be provided with the guide groove 211. Further, the guide groove 211 may not be connected to the flow-out hole 116.

Note that, in the embodiment, “plasticization” is a concept that includes melting, and refers to changing a solid into a state with fluidity. Specifically, for a material that undergoes glass transition, plasticization refers to raising a temperature of the material above the glass transition point. For a material that does not undergo glass transition, plasticization refers to raising a temperature of the material above the melting point.

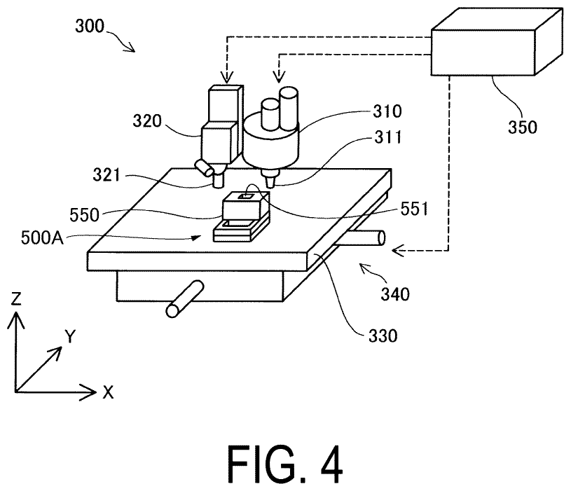

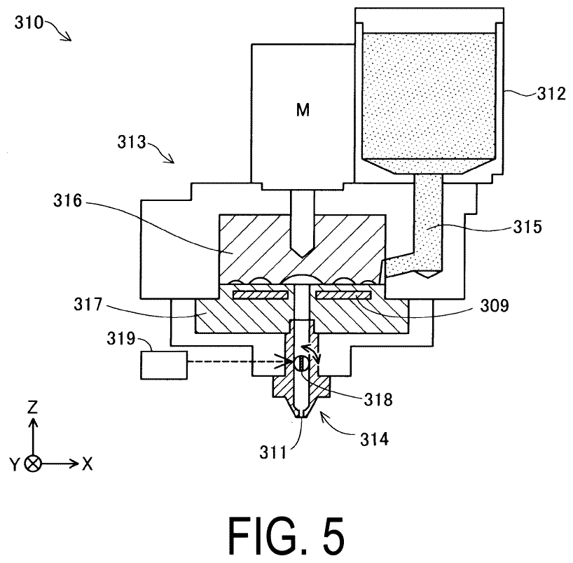

Next, with reference to FIG. 4 and FIG. 5, a configuration of a three-dimensional shaping apparatus 300 is described.

As illustrated in FIG. 4, the three-dimensional shaping apparatus 300 shapes the stacking body 550, which becomes a part of the molding die 600 used in the injection molding apparatus 10, by stacking layers. The stacking body 550 is also referred to as a shaped component.

The three-dimensional shaping apparatus 300 includes a shaping unit 310, a cutting unit 320, a stage 330, a movement mechanism 340, and a control unit 350.

The control unit 350 is configured by a computer including one or a plurality of processors, a main storage device, and an input/output interface that inputs and outputs a signal with an external device. The control unit 350 controls operations of the shaping unit 310, the cutting unit 320, and the movement mechanism 340 by the processor executing a program or a command that is read in the main storage device. Note that the control unit 350 may be configured by a combination of a plurality of circuits instead of a computer.

Under control of the control unit 350, the three-dimensional shaping apparatus 300 shapes the stacking body 550 on the stage 330 by driving the movement mechanism 340 to change the relative position of the second nozzle 311 and the stage 330 while ejecting a shaping material 550A from a second nozzle 311 provided to the shaping unit 310 onto the stage 330.

Further, under control of the control unit 350, the three-dimensional shaping apparatus 300 subjects the stacking body 550, which is stacked on the stage 330, to cutting by a cutting tool 321 to shape the cavity 551 by driving the movement mechanism 340 to change the relative position of the cutting tool 321 and the stage 330 while rotating the cutting tool 321 mounted on the cutting unit 320.

As illustrated in FIG. 5, the shaping unit 310 includes a material supply unit 312 that serves as a supply source of the material, a plasticization unit 313 that plasticizes the material to obtain the shaping material 550A, and an ejection unit 314 that ejects the shaping material.

The material supply unit 312 supplies a raw material for generating the shaping material 550A to the plasticization unit 313. For example, the material supply unit 312 is configured by a hopper that accommodates the raw material, for example. The material supply unit 312 is connected to the plasticization unit 313 via a material supply path 315 connected to the lower part of the material supply unit 312. The raw material in a form of pellets, powder, or the like is supplied into the material supply unit 312.

As the raw material, for example, a material containing a resin such as cyclic olefin copolymer (COC), acrylonitrile butadiene styrene (ABS), polyacetal (POM), polyamide (PA) 66, polyphenylene sulfide (PPS), polyether ether ketone (PEEK), and polybenzimidazole (PBI) as a main component is used. The main component refers to a component that is contained in the largest proportion by mass in the material, for example, a component that accounts for 50 mass % or more. Note that, in addition to the main component, the raw material may contain a component such as metal, ceramic, a solvent, and a binder.

The plasticization unit 313 includes a similar configuration to the plasticization device 110 of the injection molding apparatus 10 illustrated in FIG. 1. In other words, the plasticization unit 313 plasticizes the raw material by a second flat screw 316, a second barrel 317 and a second heater 309. The plasticization unit 313 plasticizes the raw material supplied from the material supply unit 312. With this, the shaping material 550A in a paste form exerting fluidity is generated, and is guided to the ejection unit 314.

The ejection unit 314 includes the second nozzle 311 that ejects the shaping material 550A generated by the plasticization unit 313 onto the stage 330. The ejection unit 314 is provided with an ejection amount adjustment unit 318 that can adjust an ejection amount of the shaping material 550A ejected from the second nozzle 311. In the embodiment, the ejection amount adjustment unit 318 is configured by a butterfly valve. The control unit 350 rotates the butterfly valve by driving a valve driving unit 319 configured by a motor or the like. With this, the ejection amount of the shaping material 550A is adjusted.

As illustrated in FIG. 4, the cutting unit 320 rotates the cutting tool 321 attached to the distal end on the stage 330 side to subject the stacking body 550 stacked on the stage 330 to cutting. For example, as the cutting tool 321, a flat-end mill or a ball-end mill may be used. The control unit 350 controls the movement mechanism 340 to change a relative position of the cutting tool 321 and the stacking body 550 stacked on the stage 330. Thus, a cutting position is controlled.

The stage 330 is supported by the movement mechanism 340. The movement mechanism 340 of the embodiment is configured as a three-axis positioner that moves the stage 330 in the X, Y, and Z directions with respect to the shaping unit 310 and the cutting unit 320. In the embodiment, the base plate 500A forming a part of the molding die 600 is removably fixed onto the stage 330, and the stacking body 550 is shaped on the base plate 500A.

Note that the movement mechanism 340 may move the shaping unit 310 and the cutting unit 320 with respect to the stage 330 instead of moving the stage 330. Further, the movement mechanism 340 may move both the stage 330, and the shaping unit 310 and the cutting unit 320. The movement mechanism 340 may include a function of inclining the stage 330 with respect to the horizontal surface, or may include a function of inclining the second nozzle 311 or the cutting tool 321.

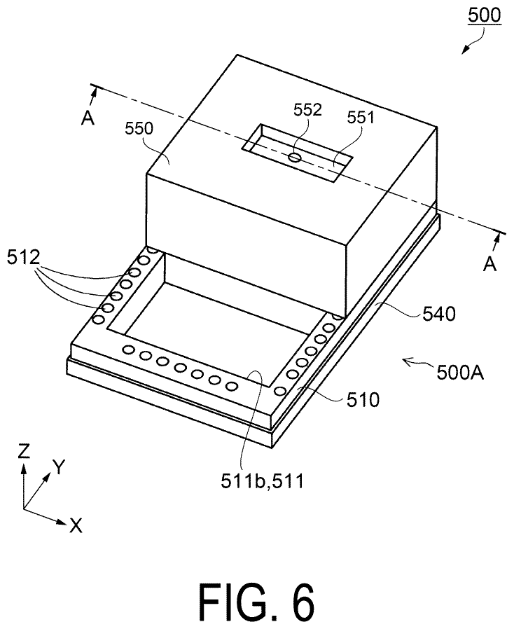

Next, with reference to FIG. 6 to FIG. 11, a configuration of the molding die 600 is described.

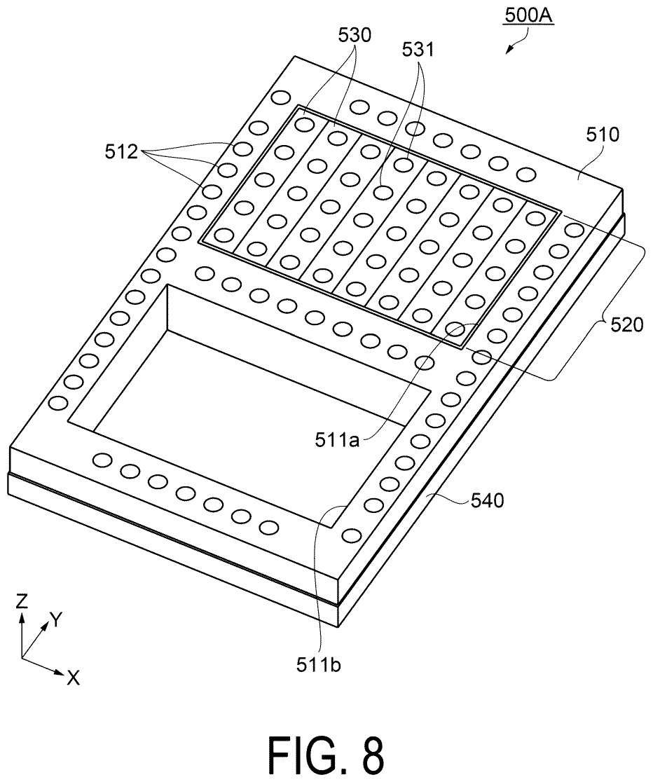

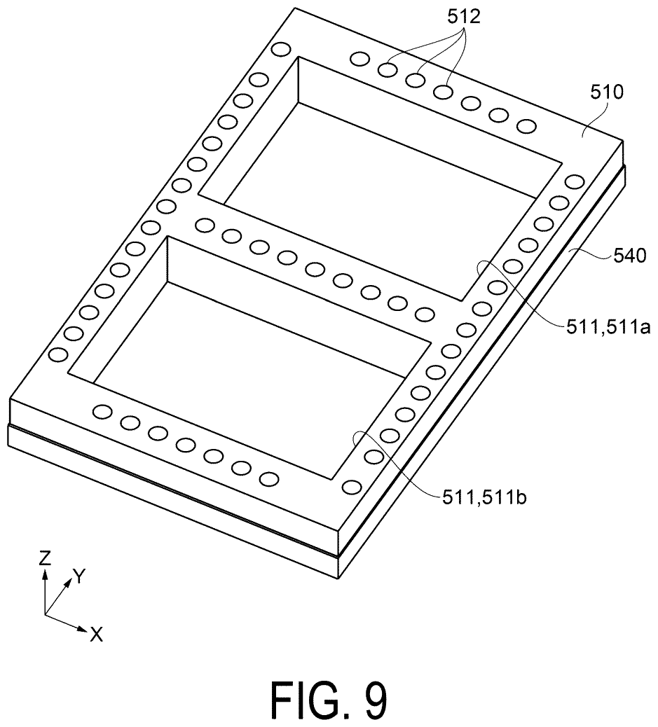

As illustrated in FIG. 6, the base plate 500A includes a first member 510 (see FIG. 9) and a second member 520 (see FIG. 8). The first member 510 and the second member 520 are formed of a metal material, for example. Note that the first member 510 and the second member 520 is not limited to metal, and may be formed of a metal such as glass and ceramic.

As illustrated in FIG. 9, in the first member 510, an opening portion 511 is formed. Specifically, in the first member 510, two opening portions 511a and 511b each having a rectangular shape are formed. The two opening portions 511a and 511b are formed so that the second member 520 (see FIG. 8) is arranged therein.

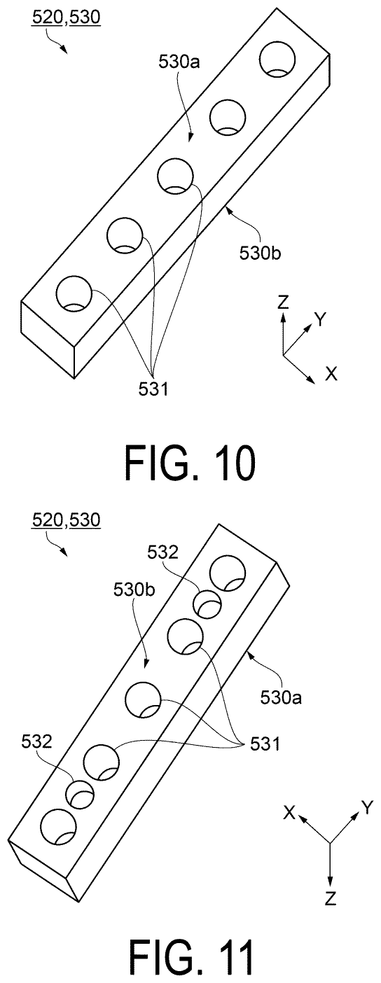

As illustrated in FIG. 8, the second member 520 is configured by a plurality of nest members 530 adhering to each other. In the embodiment, the plurality of, specifically, eight nest members 530 are provided. As illustrated in FIG. 10, the plurality of first through holes 531 are provided in the nest member 530. In the embodiment, the plurality of, specifically, five first through holes 531 are formed.

The first through hole 531 has a straight shape having a constant hole diameter from a first surface 530a of the nest member 530 where the stacking body 550 is formed to a second surface 530b opposite to the first surface 530a.

The nest eight members 530 have the same outer shapes, and the first through holes 531 thereof have the same hole diameter. In this manner, the shapes of the plurality of nest members 530 and the hole diameters of the first through holes 531 are the same. Thus, the opening portion 511a can be filled, in other words, assembly can be performed without examining the order of inserting the nest members 530 into the opening portion 511a. Further, the nest members 530 are all the same, and hence the nest member 530 can be formed without increasing formation steps.

As illustrated in FIG. 8, the longitudinal direction of the nest member 530, in other words, the Y direction is the same direction as the longitudinal direction of the base plate 500A, in other words, the direction along the Y direction. In this manner, the longitudinal direction of the nest member 530 and the longitudinal direction of the base plate 500A are aligned. Thus, the gap between the base plate 500A and the plurality of nest members 530 can be reduced, and occurrence of looseness between the opening portion 511 and the nest member 530 can be suppressed.

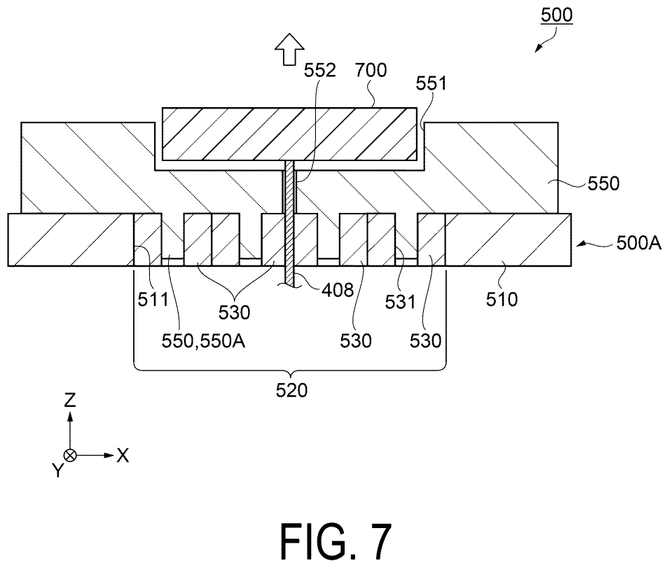

As illustrated in FIG. 7, when the stacking body 550 is formed on the base plate 500A, the shaping material 550A being a material of the stacking body 550 enters the first through hole 531. Thus, the first through hole 531 is used to enhance the adhesive force between the base plate 500A and the stacking body 550 and prevent the stacking body 550 from floating from the base plate 500A.

In this manner, the first through hole 531 is provided in the nest member 530. Thus, the shaping material 550A can enter the first through hole 531, and an anchoring effect, in other words, the adhesive force between the base plate 500A including the nest member 530 and the stacking body 550 can be improved. Note that, in the first through hole 531, a pin for extruding a product 700 from the stacking body 550 may be arranged.

As illustrated in FIG. 8, a plurality of second through holes 512, which include a function similar to that of the first through holes 531, are provided in the first member 510. Specifically, the plurality of second through holes 512 are provided in the periphery of the opening portions 511a and 511b of the first member 510. The hole diameter of the second through hole 512 is larger than the hole diameter of the first through hole 531. As the hole diameter is larger, a larger amount of the shaping material 550A enters, and the adhesive force between the stacking body 550 and the base plate 500A is enhanced more.

In this manner, the hole diameter of the second through hole 512 of the first member 510 is larger than the hole diameter of the first through hole 531 of the nest member 530. Thus, the adhesive force with the first member 510 in the stacking body 550, in other words, the adhesive force in the periphery of the nest member 530 can be improved. Thus, as compared to a case in which the adhesive force between the nest member 530 and the stacking body 550 is high, generation of warpage in the stacking body 550 can be suppressed.

As illustrated in FIG. 11, on the second surface 530b of the nest member 530, which is opposite to the first surface 530a where the stacking body 550 is formed, in other words, the surface on the side contacting with the support plate 540, a female screw portion 532 is provided. In the embodiment, two female screw portions 532 are provided to the nest member 530.

In this manner, the female screw portion 532 is formed on the nest member 530, and hence can be used when the nest member 530 is inserted into or removed from the opening portion 511 of the first member 510, for example.

As described above, the base plate 500A includes the first member 510 and the second member 520, the first member 510 is provided with the opening portion 511, the second member 520 is configured by the plurality of nest members 530 that are arrayed and arranged to fill the opening portion 511 (see FIG. 8).

In this manner, the shaping material 550A is stacked on the base plate 500A assembled by arraying the plurality of nest members 530 to fill the opening portion 511, and thus the stacking body 550 is formed. Thus, for example, the adhesive force between the stacking body 550 and one nest member 530 is less than the adhesive force between the stacking body 550 where the second member 520 is configured by one member and the second member 520. Thus, when the second member 520 is removed from the base plate 500A, the second member 520 can be removed easily in a unit of the nest member 530. In other words, the nest member 530 is removed easily from the base plate 500A. With this, the processing can proceed quickly to the subsequent step, and processing efficiency can be improved. Moreover, the required processing time can be reduced.

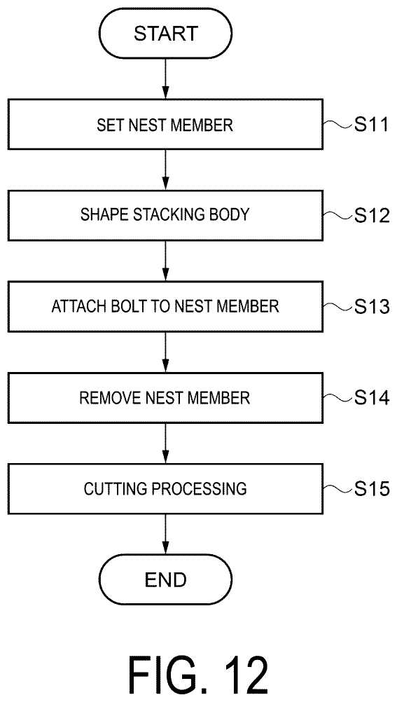

Next, with reference to FIG. 12 to FIG. 19, the method of manufacturing the movable die 500, which is a part of the method of manufacturing the molding die 600, is described.

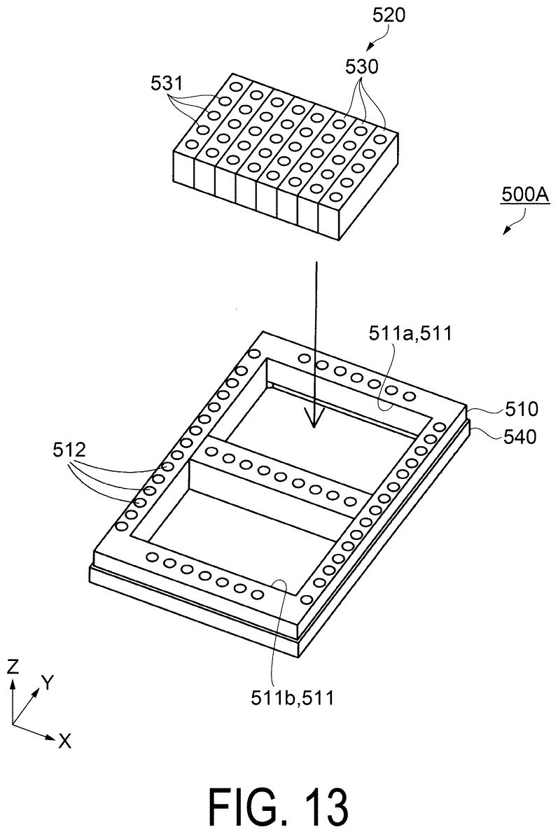

As illustrated in FIG. 12, in step S11, the first member 510 and the second member 520 are combined with each other to acquire the base plate 500A. Specifically, as illustrated in FIG. 13, the plurality of nest members 530 are arrayed and inserted to fill the opening portion 511 of the first member 510. Note that, in the embodiment, the plurality of nest members 530 are inserted into only one opening portion 511a.

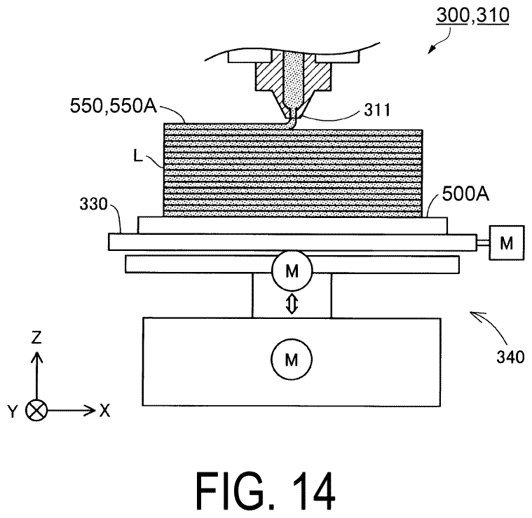

Subsequently, in step S12, the stacking body 550 is shaped. Specifically, as illustrated in FIG. 14, the three-dimensional shaping apparatus 300 is used to eject the shaping material 550A and stack a layer on the base plate 500A fixed to the stage 330. With this, the stacking body 550, which becomes a part of the molding die 600, is shaped.

As illustrated in FIG. 14, in the three-dimensional shaping apparatus 300, the plasticization unit 313 of the shaping unit 310 (see FIG. 5) plasticizes the raw material in a solid state to generate the shaping material 550A. As illustrated in FIG. 4, the control unit 350 causes the second nozzle 311 to eject the shaping material 550A while maintaining the distance between the stage 330 and the second nozzle 311 and changing the position of the second nozzle 311 with respect to the stage 330 in the direction along the upper surface of the stage 330. The shaping material 550A ejected from the second nozzle 311 is accumulated on the base plate 500A successively in the movement direction of the second nozzle 311 to form a layer L.

The control unit 350 repeats scanning of the second nozzle 311 to form a plurality of layers L. More specifically, after one layer L is formed, the control unit 350 moves the position of the second nozzle 311 with respect to the stage 330 in the Z direction. Further, a layer L is further stacked on the layer L thus formed. With this, the stacking body 550 is shaped.

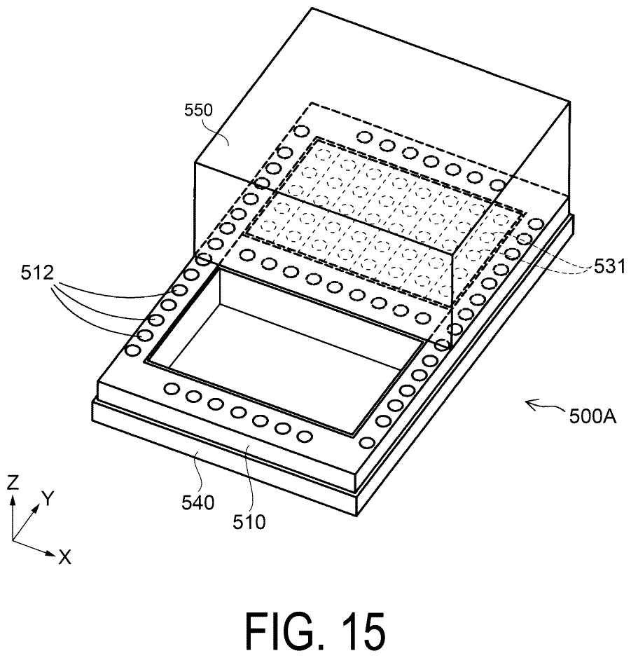

As illustrated in FIG. 15, in the base plate 500A, the plurality of through holes 512 and 531 are formed in a surface on which the stacking body 550 is stacked. Thus, the second nozzle 311 moves across the through holes 512 and 531, and the shaping material 550A is ejected. With this, a part of the shaping material 550A enters the through holes 512 and 531, and an anchoring effect is exerted by the through holes 512 and 531. Thus, during shaping of the stacking body 550, peeling of the stacking body 550 from the base plate 500A can be suppressed.

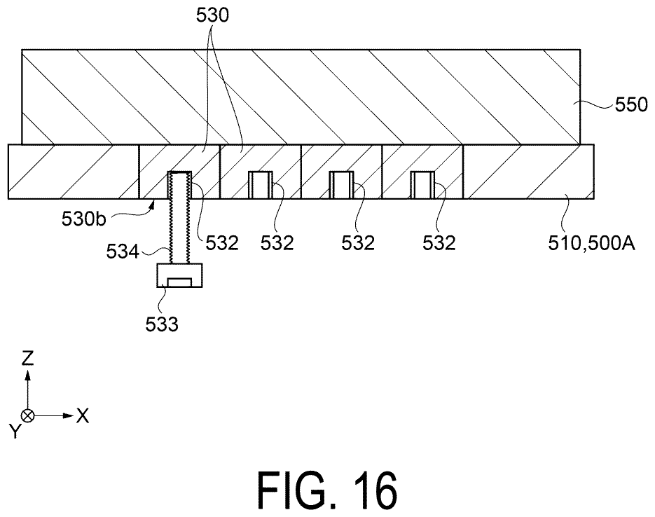

Subsequently, in step S13, the second member 520 is removed from the base plate 500A. Specifically, as illustrated in FIG. 16, a bolt member 533 is attached to the female screw portion 532 from the second surface 530b side of the nest member 530. On the bolt member 533, a male screw portion 534 corresponding to the female screw portion 532 is formed.

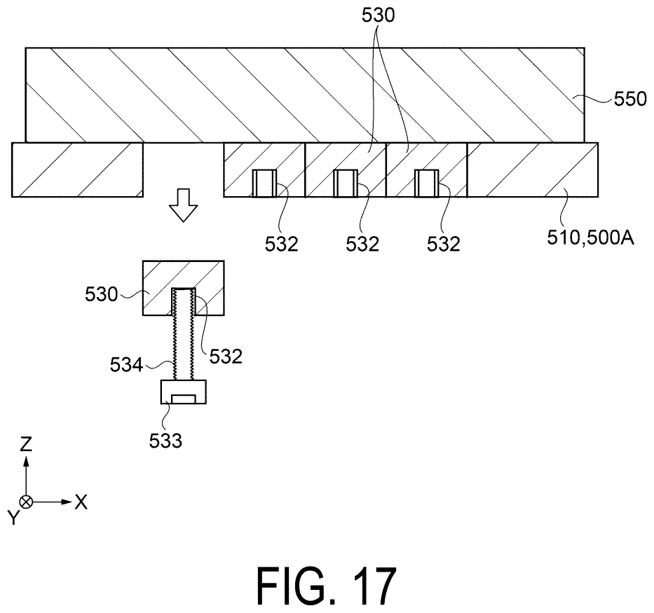

Subsequently, in step S14, the nest member 530 is removed from the first member 510. Specifically, as illustrated in FIG. 17, the bolt member 533 to which the nest member 530 is attached is pulled. With this, one nest member 530 is removed from the first member 510. Then, the remaining nest members 530 are removed from the first member 510. With this, removal of the second member 520 from the base plate 500A is completed.

In this manner, the bolt member 533 is joined to the female screw portion 532, and the nest member 530 is pulled from the base plate 500A together with the bolt member 533. Thus, the nest member 530 can be extracted relatively easily from the base plate 500A. Thus, as compared to a case in which the bolt member 533 is not provided, manufacturing efficiency can be improved, and manufacturing time can be reduced.

Further, the stacking body 550 is shaped on the base plate 500A assembled by inserting the plurality of nest members 530 into the opening portion 511 of the first member 510. Thus, for example, the adhesive force between the stacking body 550 and one nest member 530 is less than the adhesive force between the stacking body 550 where the second member 520 is configured by one member and the second member 520. Thus, when the second member 520 is removed from the base plate 500A, the second member 520 can be removed easily in a unit of the nest member 530. In other words, the nest member 530 is removed easily from the base plate 500A. With this, the processing can proceed quickly to the subsequent step, which is the cutting process, and processing efficiency can be improved. Moreover, the required processing time can be reduced.

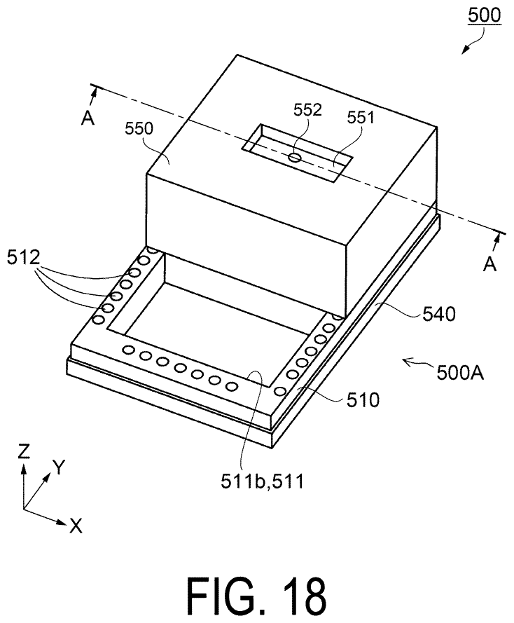

Subsequently, in step S15, the cutting processing is executed. Specifically, as illustrated in FIG. 4, the cutting unit 320 is used to subject the stacking body 550 to the cutting processing. As illustrated in FIG. 18, the cutting processing is executed. With this, the cavity 551 having a recess shape is formed in the stacking body 550. Note that a cavity having a protruding shape may be formed in the stacking body 550. Further, the number of cavities 551 is not limited to one, and two or more cavities 551 may be formed.

Note that, in the stacking body 550, the through hole 552 into which the ejector pin 408 is inserted may be formed in the bottom portion of the cavity 551 by using the cutting unit 320. The nest member 530 is removed from the base plate 500A in advance. Thus, formation of the through hole 552 by the cutting unit 320 is not interrupted by the nest member 530.

Note that, during the cutting processing, not only the cavity 551 and the through hole 552 but also the front surface or the side surface of the stacking body 550 may be subjected to cutting. Further, prior to the cutting processing, it is not limited to removing all the nest members 530 from the base plate 500A. Alternatively, the nest member 530 corresponding to a part that affects the cutting processing may be removed.

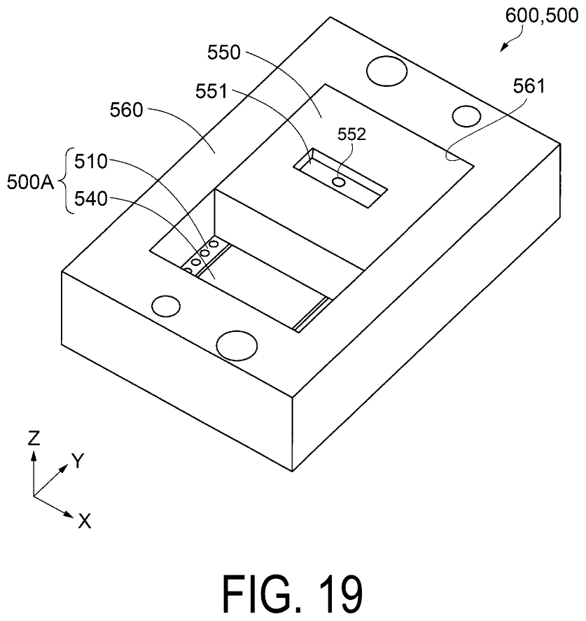

In the subsequent step, as illustrated in FIG. 19, the base plate 500A on which the stacking body 550 is shaped is inserted into an opening portion 561 of the mold base 560. The mold base 560 is a metal material, for example. The mold base 560 includes a bottom portion, for example. In this state, the nest member 530 may be inserted into the first member 510 forming the base plate 500A, or the nest member 530 may be removed. With this, the movable die 500 being a part of the molding die 600 is completed. The molding die 600 manufactured as described above is attached to the injection molding apparatus 10 (see FIG. 1), and is used for injection molding.

As described above, the method of manufacturing the molding die 600 of the embodiment is the method of manufacturing the molding die 600 used in the injection molding apparatus 10, and includes assembling the base plate 500A by inserting the second member 520 into the opening portion 511 of the first member 510, the second member 520 being configured by the plurality of nest members 530, shaping the stacking body 550 being a part of the molding die 600 by ejecting the shaping material 550A onto the base plate 500A and stacking the layer L, removing the second member 520 from the base plate 500A on which the stacking body 550 is shaped, and subjecting the stacking body 550 to a cutting process, wherein, during assembling of the base plate 500A, the plurality of nest members 530 are arrayed and inserted to fill the opening portion 511.

According to this method, the stacking body 550 is shaped on the base plate 500A assembled by inserting the plurality of nest members 530 into the opening portion 511. Thus, for example, the adhesive force between the stacking body 550 and one nest member 530 is less than the adhesive force between the stacking body 550 where the second member 520 is configured by one member and the second member 520. Thus, when the second member 520 is removed from the base plate 500A, the second member 520 can be removed easily in a unit of the nest member 530. In other words, the nest member 530 is removed easily from the base plate 500A. Further, in other words, the stacking body 550 and the nest member 530 peel off from each other easily. With this, the processing can proceed quickly to the subsequent step, which is the cutting process, and processing efficiency can be improved. Moreover, the required processing time can be reduced.

Further, the second member 520 is configured by the plurality of nest members 530. Thus, the ejector pin 408 can be arranged selectively. Moreover, the nest member 530 can be arranged according to the size of the stacking body 550 to be shaped, and there is no need to prepare more nest members 530 than necessary. Further, the first through hole 531 is provided in the nest member 530. Thus, an anchoring effect can be obtained in a unit of the nest member 530. Even when the stacking body 550 is shaped selectively, the stacking body 550 can be shaped without affecting the shaping.

Further, in the method of manufacturing the molding die 600 of the embodiment, the nest member 530 may include at least one first through hole 531. According to this method, the first through hole 531 is provided in the nest member 530. Thus, the shaping material 550A can enter the first through hole 531, and an anchoring effect, in other words, the adhesive force between the base plate 500A including the nest member 530 and the stacking body 550 can be improved. Further, for example, in the first through hole 531 or another through hole 552, the ejector pin 408 for extruding the product 700 from the stacking body 550 may be arranged.

Further, in the method of manufacturing the molding die 600 of the embodiment, the plurality of nest members 530 may have the same shape, and the hole diameters of the first through holes 531 may be the same. According to this method, the shapes of the plurality of nest members 530 and the hole diameters of the first through holes 531 are the same. Thus, the opening portion 511 can be filled with the nest member 530 without examining the order of inserting the nest members 530 into the opening portion 511. Further, the nest members 530 are all the same, and hence the nest member 530 can be formed without increasing formation steps.

Further, in the method of manufacturing the molding die 600 of the embodiment, the female screw portion 532 may be formed on a side of the nest member 530, which is opposite to a side where the stacking body 550 is formed. According to this method, the female screw portion 532 is formed on the nest member 530, and hence can be used when the nest member 530 is inserted into or removed from the opening portion 511 of the first member 510, for example.

Further, in the method of manufacturing the molding die 600 of the embodiment, the bolt member 533 including the male screw portion 534 corresponding to the female screw portion 532 may be provided. According to this method, the bolt member 533 corresponding to the female screw portion 532 is provided. Thus, the bolt member 533 can be attached to the female screw portion 532, and the molding die 600 can be assembled or disassembled.

Further, in the method of manufacturing the molding die 600 of the embodiment, during removal of the second member 520, the bolt member 533 may be joined to the female screw portion 532, and the nest member 530 may be removed from the base plate 500A together with the bolt member 533. According to this method, the bolt member 533 is joined to the female screw portion 532 of the nest member 530. Thus, when the bolt member 533 is pulled, the nest member 530 can be extracted relatively easily from the base plate 500A. Thus, as compared to a case in which the bolt member 533 is not provided, manufacturing efficiency can be improved, and manufacturing time can be reduced.

Further, in the method of manufacturing the molding die 600 of the embodiment, the longitudinal direction of the nest member 530, in other words, the direction along the Y direction may be the same as the longitudinal direction of the base plate 500A, in other words, the direction along the Y direction. According to this method, the gap between the base plate 500A and the plurality of nest members 530 can be reduced, and occurrence of looseness between the opening portion 511 and the nest member 530 can be suppressed. Further, the nest member 530 is not unnecessarily elongated, and hence strength of the nest member 530 can be maintained.

Further, in the method of manufacturing the molding die 600 of the embodiment, the first member 510 may include the second through hole 512, and the hole diameter of the second through hole 512 may be larger than the hole diameter of the first through hole 531. According to this method, the hole diameter of the second through hole 512 of the first member 510 is larger than the hole diameter of the first through hole 531 of the nest member 530. Thus, the adhesive force with the first member 510 in the stacking body 550, in other words, the adhesive force in the periphery of the nest member 530 can be improved. Thus, as compared to a case in which the adhesive force between the nest member 530 and the stacking body 550 is high, generation of warpage in the stacking body 550 can be suppressed.

Further, the base plate 500A of the embodiment may be the base plate 500A on which the shaping material 550A is stacked, the base plate 500A being used in the injection molding apparatus 10 and including the first member 510 and the second member 520, wherein the first member 510 may be provided with the opening portion 511, and the second member 520 may be configured by the plurality of nest members 530 that are arrayed and arranged to fill the opening portion 511.

According to this configuration, the shaping material 550A is stacked on the base plate 500A where the plurality of nest members 530 are arrayed and arranged to fill the opening portion 511, and thus the stacking body 550 is formed. Thus, for example, the adhesive force between the stacking body 550 and one nest member 530 is less than the adhesive force between the stacking body 550 where the second member 520 is configured by one member and the second member 520. Thus, when the second member 520 is removed from the base plate 500A, the second member 520 can be removed easily in a unit of the nest member 530. In other words, the nest member 530 is removed easily from the base plate 500A. With this, the processing can proceed quickly to the subsequent step, and processing efficiency can be improved. Moreover, the required processing time can be reduced.

Modifications of the embodiment described above are described below.

As described above, the first through hole 531 of the nest member 530 is not limited to a shape having a constant hole diameter from the first surface 530a where the stacking body 550 is formed to the second surface 530b opposite to the first surface 530a, and may have a tapered shape.

Specifically, for example, the first through hole 531 may have a tapered shape in which the hole diameter is reduced from the first surface 530a of the nest member 530 where the stacking body 550 is formed to the second surface 530b opposite to the first surface 530a.

According to this method, the hole diameter is reduced from the first surface 530a to the second surface 530b, in other words, the hole diameter on the stacking body 550 side is larger, and the hole diameter on the support plate 540 side is smaller. Thus, the stacking body 550 and the nest member 530 can be separated easily. Note that the taper shape is not limited to the first through hole 531, and may be applied to the second through hole 512 of the first member 510.

The shape of the nest member 530 is not limited to a rectangular parallelepiped shape described above, and maybe a shape that can be inserted into the opening portion 511 of the first member 510. For example, a combination of a nest member having a recess shape in plan view and a nest member having a rectangular parallelepiped shape may be adopted, or a combination of small shapes obtained by dividing the nest member 530 into halves may be adopted.

What is claimed is:

1. A method of manufacturing a molding die used in an injection molding apparatus, the method comprising:
assembling a base plate by inserting a second member into an opening portion of a first member, the second member being configured by a plurality of nest members;
shaping a stacking that is to be a part of the molding die by ejecting a shaping material onto the base plate and stacking a layer;
removing the second member from the base plate on which the stacking body was shaped; and
subjecting the stacking body to a cutting process, wherein
during assembling of the base plate, the plurality of nest members are arrayed and inserted to fill the opening portion.

2. A method of manufacturing a molding die according to claim 1, wherein
the nest member includes at least one first through hole.

3. A method of manufacturing a molding die according to claim 2, wherein
the plurality of nest members have the same shape, and hole diameters of the first through holes are the same.

4. A method of manufacturing a molding die according to claim 1, wherein
the nest member includes a female screw portion formed on a side opposite to a side on which the stacking body is formed.

5. A method of manufacturing a molding die according to claim 4, comprising:
a bolt member including a male screw portion corresponding to the female screw portion.

6. A method of manufacturing a molding die according to claim 5, wherein
during removal of the second member, the bolt member is joined to the female screw portion, and the nest member is removed from the base plate together with the bolt member.

7. A method of manufacturing a molding die according to claim 1, wherein
a longitudinal direction of the nest member is the same as a direction along a longitudinal direction of the base plate.

8. A method of manufacturing a molding die according to claim 2, wherein
the first through hole has a taper shape in which the hole diameter is reduced from a first surface of the nest member where the stacking body is formed to a second surface opposite to the first surface.

9. A method of manufacturing a molding die according to claim 2, wherein
the first member includes a second through hole, and
a hole diameter of the second through hole is larger than the hole diameter of the first through hole.

10. A base plate on which a shaping material is stacked, the base plate being used in an injection molding apparatus and comprising a first member and a second member, wherein
the first member is provided with an opening portion, and
the second member is configured by a plurality of nest members that are arrayed and arranged to fill the opening portion.
